(19) United States
(12) Patent Application Publication
(10) Pub. No.: US 2018/0196271 A1
(43) Pub. Date: Jul. 12, 2018

(54) LIGHT MODULATION SYSTEM AND LIGHT SOURCE ILLUMINATION DEVICE THEREOF

(71) Applicant: ELECTRONICS AND TELECOMMUNICATIONS RESEARCH INSTITUTE, Daejeon (KR)

(72) Inventors: Keehoon HONG, Daejeon (KR); Yongjun LIM, Sejong (KR)

(21) Appl. No.: 15/825,029

(22) Filed: Nov. 28, 2017

(30) Foreign Application Priority Data
Jan. 9, 2017 (KR) 10-2017-0003126

(51) Int. Cl. G02B 27/10; G02B 6/28; G02B 27/09

(52) U.S. Cl. CPC G02B 27/1026; G02B 27/0977; G02B 27/095; G02B 6/28

(57) ABSTRACT

Disclosed is a light modulation system and a light source illumination device thereof. The light modulation system may include: a first diffractive optical element for expanding optical beams from a light source; an optical waveguide for performing total internal reflection of the expanded optical beams and transmitting resultant optical beams; a second diffractive optical element for modifying an angle of the transmitted optical beams; and a digital micro-mirror device for modulating the angle-modified optical beams.

### CROSS-REFERENCE TO RELATED APPLICATION

This application claims priority to and the benefit of Korean Patent Application No. 10-2017-0003126 filed in the Korean Intellectual Property Office on Jan. 9, 2017, the entire contents of which are incorporated herein by reference.

### BACKGROUND OF THE INVENTION

### (a) Field of the Invention

The present invention relates to a light modulation system and a light source illumination device.

### (b) Description of the Related Art

Digital holography represents a technique for simultaneously recording intensity information of light and phase information by using laser beams, which are a coherent light source. Digital holography is used in various fields such as holographic displays and holographic printing devices for reproducing three-dimensional images, hologram storage devices that are large-capacity storage media, and holographic microscopes for imaging.

To realize an application system by using digital holography, a spatial light modulator for modulating intensity of light or phase information is required. In general, the spatial light modulator used for digital holography includes liquid crystal (LC), liquid crystal on silicon (LCoS), and a digital micro-mirror device (DMD).

The DMD is a device in which micro-mirrors are arranged by using a micro-electromechanical process, it adjusts angles of respective mirrors to control image information of pixels, and it has the merits of high contrast ratios, fast driving speeds, and low costs. One of a plurality of element mirrors arranged on the DMD has three states of flat, on, and off. The case in which no power voltage is applied represents the flat state. The element mirror corresponding to the pixel on a position to be modulated is electrically controlled to inclined states of (+/−) θ°. The cases of being inclined in the states of (+/−)θ° correspond to on and off, respectively. Black and white information on pixels may be modulated by programming the on and off states of the element mirrors, and they may be modulated into gray or color images through time or light source multiplexing. In general, θ is a value that is determined when the DMD is manufactured. When a modulated image is projected to perpendicular direction from the DMD, an incident angle of the light source is set to be 2θ°.

To modulate the coherent light source such as laser beams through the DMD, an area of laser beams of the coherent light source must be greater than a valid driving area of the DMD, and a condition of the incident angle (the incident angle of the light source) to the DMD must be satisfied. A beam width of the coherent light source such as general laser beams is very much less than the valid driving area of the DMD. The incident angle to the DMD may be adjusted by a device for adjusting a steering direction of the coherent light source or an optical system for adjusting an incident angle for modifying an optical path. The beam width of the light source may be adjusted through a beam expanding optical system. That is, coherent light generated by the light source satisfies the conditions on the area and the incident angle by the light source illumination device including a beam expanding optical system and an incident angle adjusting optical system. Light modulated by the DMD is transmitted to a projection optical system used for respective application fields.

In the case of using the beam expanding optical system and the incident angle adjusting optical system, it is needed to obtain an optical path that is greater than a specific length so as to prevent beam path overlap between the incident beam and the output beam modulated by the DMD. That is, the length of the entire system increases. The beam expanding optical system and the incident angle adjusting optical system have constant volumes, so it is difficult to down-size them.

A method for adjusting the incident angle by use of a total internal reflection prism and separating the incident beam and the output beam modulated by the DMD is provided. However, when the total internal reflection prism is used, a predetermined optical path is required, and it is difficult to down-size the same because of the volume of the total internal reflection prism.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide a light modulation system for allowing down-sizing by reducing a size and a thickness thereof, and a light source illumination device thereof.

An exemplary embodiment of the present invention provides a light modulation system. The light modulation system may include: a first diffractive optical element for expanding optical beams from a light source; an optical waveguide for performing total internal reflection to the expanded optical beams and transmitting resultant optical beams; a second diffractive optical element for modifying an angle of the transmitted optical beams; and a digital micromirror device for modulating the angle-modified optical beams.

The second diffractive optical element may additionally extend the transmitted optical beams.

The first diffractive optical element and the second diffractive optical element may be provided on the optical waveguide.

The first diffractive optical element may change a path of the optical beams from the light source so that the expanded optical beams may be totally reflected on the optical waveguide.

The first diffractive optical element may have a reflective structure, the second diffractive optical element may have a transmissive structure, and the first diffractive optical element and the second diffractive optical element may be provided on an opposite side of a place where the light source is provided with respect to the optical waveguide.

The first diffractive optical element may have a transmissive structure, the second diffractive optical element may have a reflective structure, and the first diffractive optical element and the second diffractive optical element may be provided on a same side of a place where the light source is provided with respect to the optical waveguide.

The first diffractive optical element may have a reflective structure, the second diffractive optical element may have a transmissive structure, the first diffractive optical element may be provided on an opposite side of a place where the light source is provided with respect to the optical waveguide, and the second diffractive optical element and the DMD may be provided on a same side of the place where the light source is provided with respect to the optical waveguide.

The light modulation system may further include a projection optical system for projecting the modulated optical beams.

The light source may be a coherent light source.

The light modulation system may further include a beam expanding optical system for expanding the optical beams from the light source and outputting the expanded optical beams to the first diffractive optical element.

The second diffractive optical element may convert the transmitted optical beams into a waveform for optical modulation.

Another embodiment of the present invention provides a light source illumination device for changing optical beams from a light source and transmitting resultant optical beams to a spatial light modulator. The light source illumination device may include: a first diffractive optical element for expanding the optical beams; an optical waveguide for applying total internal reflection of the expanded optical beams and transmitting resultant optical beams; and a second diffractive optical element for inputting the transmitted optical beams into the spatial light modulator.

The second diffractive optical element may additionally extend the transmitted optical beams.

The first diffractive optical element may change a path of the optical beams from the light source so that the expanded optical beams may be totally reflected on the optical waveguide.

The first diffractive optical element may have a reflective structure, the second diffractive optical element may have a transmissive structure, and the first diffractive optical element and the second diffractive optical element may be provided on an opposite side of a place where the light source is provided with respect to the optical waveguide.

The first diffractive optical element may have a transmissive structure, the second diffractive optical element may have a reflective structure, and the first diffractive optical element and the second diffractive optical element may be provided on a same side of a place where the light source is provided with respect to the optical waveguide.

The light source illumination device may further include a beam expanding optical system for expanding the optical beams from the light source and outputting the expanded optical beams to the first diffractive optical element.

Yet another embodiment of the present invention provides a method for operating a light modulation system for modulating optical beams generated by a light source. The method may include: expanding optical beams from the light source by using a first diffractive optical element; applying total internal reflection of the expanded optical beams and transmitting resultant optical beams; modifying an angle of the transmitted optical beam by using a second diffractive optical element; and modulating the angle-modified optical beams.

The method may further include changing a path of the optical beams from the light source by using the first diffractive optical element so that the expanded optical beams may be totally reflected.

According to the exemplary embodiment of the present invention, the light modulation system may be down-sized by using a diffractive optical element such as a holographic optical element.

According to the exemplary embodiment of the present invention, the light modulation system may be further down-sized by reducing the optical path by use of an optical waveguide.

According to the exemplary embodiment of the present invention, freedom of disposal of the coherent light source increases by using the optical waveguide and the diffractive optical element, so it becomes easy to modify the design of the light modulation system.

According to the exemplary embodiment of the present invention, the cost may be reduced by replacing the conventional optical system with a low-cost diffractive optical element.

### BRIEF DESCRIPTION OF THE DRAWINGS

FIG. 1 shows a light modulation system according to an exemplary embodiment of the present invention.

FIG. 2 shows a flowchart of a method for operating a light modulation system according to an exemplary embodiment of the present invention.

FIG. 3 shows a case when first and second diffractive optical elements according to an exemplary embodiment of the present invention have selectivity on a multi-color wavelength.

FIG. 4 shows a light modulation system according to another exemplary embodiment of the present invention.

FIG. 5 shows a light modulation system according to the other exemplary embodiment of the present invention.

FIG. 6 shows a light modulation system according to the other exemplary embodiment of the present invention.

FIG. 7 shows a light modulation system according to the other exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

Throughout this specification and the claims that follow, when it is described that an element is “coupled” to another element, the element may be “directly coupled” to the other element or “electrically coupled” to the other element through a third element. Unless explicitly described to the contrary, the word “comprise” and variations such as “comprises” or “comprising” will be understood to imply the inclusion of stated elements but not the exclusion of any other elements.

A light modulation system according to an exemplary embodiment of the present invention, and a light source illumination device thereof, will now be described.

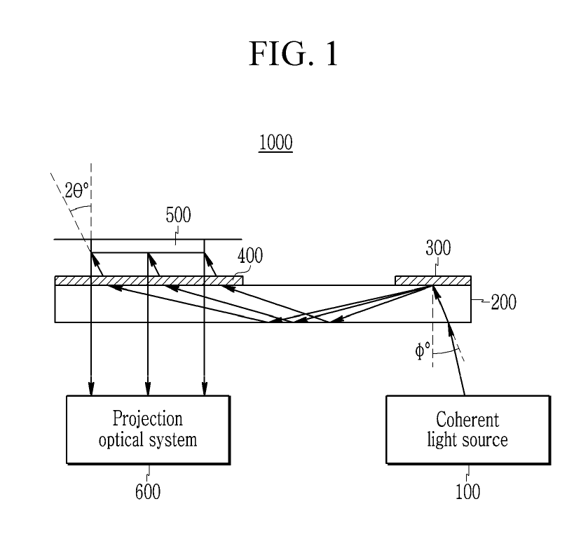

FIG. 1 shows a light modulation system 1000 according to an exemplary embodiment of the present invention.

As shown in FIG. 1, the light modulation system 1000 includes a coherent light source 100, an optical waveguide 200, a first diffractive optical element (DOE) 300, a second diffractive optical element 400, a digital micro-mirror device (DMD) 500, and a projection optical system 600.

The coherent light source 100 generates a coherent light source such as laser beams. The coherent light source 100 may use a single-wavelength coherent light source or a multi-color-wavelength coherent light source. The multi-color wavelength coherent light source may be used for displaying red, green, and blue (RGB) colors.

The optical waveguide 200 inputs the light output by the coherent light source 100 to the first diffractive optical element 300, applies total internal reflection of the optical beams output (or expanded) by the first diffractive optical element 300, and transmits resultant beams to the second diffractive optical element 400. Light with a small beam width output by the coherent light source 100 is input to the optical waveguide 100, it is refracted according to Snell's law, and it is then input to the first diffractive optical element 300 at the incident angle of φ. In this instance, the incident angle (φ) and the total internal reflection angle of the optical waveguide 200 are changeable by modifying a specification of the first diffractive optical element 300 according to an application example of the light modulation system 1000. The optical waveguide 200 according to an exemplary embodiment of the present invention reduces the path of optical beams through the total internal reflection, thereby down-sizing the light modulation system 1000.

The first diffractive optical element 300 is provided on a portion where light of the coherent light source 100 is input on the optical waveguide 200. The first diffractive optical element 300 extends (or diffuses) the optical beams of the coherent light source 100. The first diffractive optical element 300 changes the angle of the optical beams so that the incident optical beams may be totally reflected and proceed in the optical waveguide 200. That is, the first diffractive optical element 300 diffuses the optical beams and changes the path of the optical beams.

The optical beams diffused by the first diffractive optical element 300 are totally reflected several times in the optical waveguide 200 and are then input to the second diffractive optical element 400. A number of total internal reflections in the optical waveguide 200 represents a factor for determining the expanding ratio of beams and the position of the second diffractive optical element 400. Here, the number of total internal reflections may be changed through a length and thickness of the optical waveguide 200 according to an application example of the light modulation system 1000.

The second diffractive optical element 400 is provided on a portion where the optical beams are output to the DMD 500 on the optical waveguide 200. The second diffractive optical element 400 changes the optical beams in a diffusion form while being totally reflected and transmitted in the optical waveguide 200 into a waveform satisfying an optical modulation purpose, and inputs the resultant waveform to the DMD 500. That is, the second diffractive optical element 400 performs a function of additionally diverging (or expanding) the optical beams, a function of changing the optical beams that are input in a diverged form into a waveform that is appropriate for the modulation purpose, and a function of changing the angle of the optical beams to satisfy the condition of the incident angle (2θ) required by the DMD 500. The drawings of the present invention show an example in which the second diffractive optical element 400 changes the optical beams into a collimated waveform and inputs the same at the incident angle (2θ).

The first diffractive optical element 300 and the second diffractive optical element 400 represent diffractive optical elements that realize functions of a lens and a prism into thin films, and concrete configurations thereof are known to a person skilled in the art and will not be described. The first diffractive optical element 300 and the second diffractive optical element 400 may be manufactured by attaching a diffractive optical element manufactured in a different environment to the optical waveguide 200 or patterning the same on the optical waveguide 200.

The first diffractive optical element 300 may be a reflective structure, and the second diffractive optical element 400 may be a transmissive structure. In this instance, as shown in FIG. 1, the first diffractive optical element 300 and the second diffractive optical element 400 are provided to be opposite to the coherent light source 100 with respect to the optical waveguide 200.

FIG. 1 shows the case in which the first diffractive optical element 300 is configured to be a reflective structure in which the incident beam is provided in an opposite direction of the diffracted beam, and it may be configured to be a transmissive structure in which the incident beam is provided in a same direction of the diffracted beam according to the application field of the light modulation system 1000. FIG. 1 shows the case in which the second diffractive optical element 400 is configured to be a transmissive structure, and it may be configured to be a reflective structure according to the application field of the light modulation system 1000.

The DMD 500 modulates the optical beams input by the second diffractive optical element 400. The DMD 500 has a form in which a plurality of micro-mirrors are arranged through a micro-electromechanical process, and the micro-mirrors configure an element mirror. The element mirror may have three states of flat, on, and off. The case in which no power voltage is applied represents the flat state. The element mirror corresponding to the pixel on a position to be modulated is electrically controlled to inclined states of (+/−)θ°. The cases of being inclined in the states of (+/−)θ° correspond to on and off, respectively. Black and white information on pixels may be modulated by programming the on and off states of the element mirrors, and they may be modulated into gray or color images through time or light source multiplexing.

The projection optical system 600 projects the optical beams modulated by the DMD 500 and displays the same to the outside. For ease of description, FIG. 1 shows the modulated beams transmitted to the projection optical system 600 as a collimated waveform, which is modifiable depending on the application field of the light modulation system 1000.

The optical waveguide 200, the first diffractive optical element 300, and the second diffractive optical element 400 configure a light source illumination device. In the prior art, the light source illumination device is realized with a beam expanding optical system and an incident angle adjusting optical system so it was difficult to be down-sized. However, the light source illumination device according to an exemplary embodiment of the present invention may be down-sized by using the diffractive optical element that may be realized to be small and the optical waveguide for reducing the optical path.

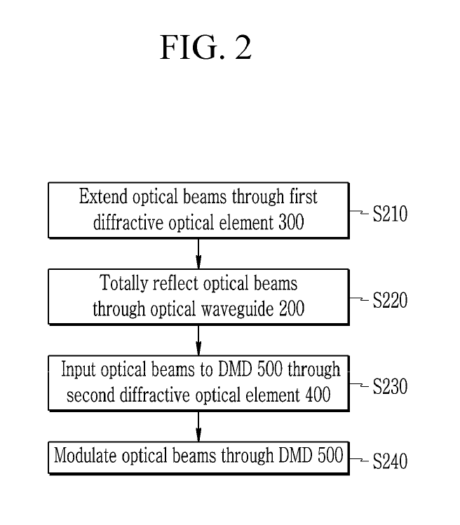

FIG. 2 shows a flowchart of a method for operating a light modulation system 1000 according to an exemplary embodiment of the present invention.

The light modulation system 1000 according to an exemplary embodiment of the present invention extends the optical beams through the first diffractive optical element 300 (S210). Light of the coherent light source 100 is input to the first diffractive optical element 300, and the first diffractive optical element 300 expands (or diverges) the optical beam and modifies the optical beam to a predetermined angle so that the optical beams may be totally reflected on the optical waveguide 200.

The light modulation system 1000 applies total internal reflection to the optical beams through the optical waveguide 200 (S220). The optical beams diffused by the first diffractive optical element 300 are totally reflected several times on the optical waveguide 200, and the resultant beams are input to the second diffractive optical element 400.

The light modulation system 1000 inputs the optical beams to the DMD 500 through the second diffractive optical element 400 (S230). The second diffractive optical element 400 changes the angle of the optical beams that are totally reflected by the optical waveguide 200 so as to satisfy the condition of the incident angle (2θ), and inputs the resultant beams to the DMD 500.

Finally, the light modulation system 1000 modulates the optical beams through the DMD 500 (S240). That is, the DMD 500 modulates the optical beams output by the second diffractive optical element 400.

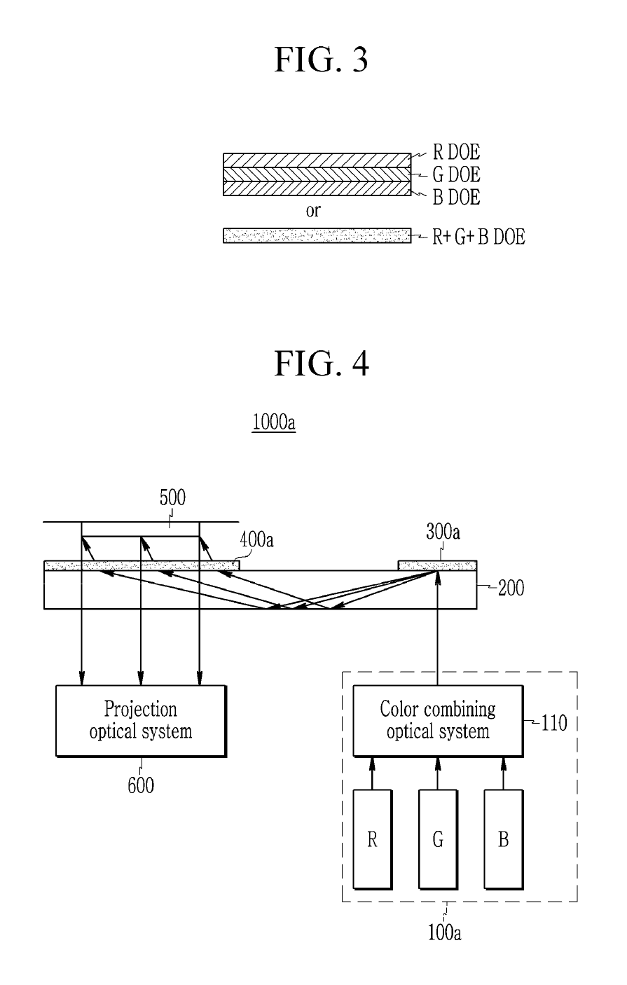

It has been described with reference to FIG. 1 and FIG. 2 that the coherent light source 100 has a single wavelength, and the same may have a multi-color wavelength. When the multi-color wavelength coherent light source 100 is used, the first and second diffractive optical elements 300 and 400 have wavelength selectivity. FIG. 3 shows a case when first and second diffractive optical elements 300 and 400 according to an exemplary embodiment of the present invention use a light source with a multi-color wavelength. As shown in FIG. 3, the first and second diffractive optical elements 300 and 400 may stack the diffractive optical elements with different wavelength selectivity and may function for the multi-color wavelength. That is, the diffractive optical element (R DOE) with R (red) wavelength selectivity, the diffractive optical element (G DOE) with G (green) wavelength selectivity, and the diffractive optical element (B DOE) with B (blue) wavelength selectivity may be stacked. The first and second diffractive optical elements 300 and 400 may have multi-color wavelength selectivity by using diffractive optical elements (R+G+B DOE) reacting to a plurality of wavelengths.

FIG. 4 shows a light modulation system 1000a according to another exemplary embodiment of the present invention.

The light modulation system 1000a represents a color displaying system that is similar to that described with reference to FIG. 1, except for a coherent light source 100a, and first and second diffractive optical elements 300a and 400a with multi-color wavelength selectivity. As shown in FIG. 4, the coherent light source 100a includes multi-color coherent light sources (R, G, and B) for generating multi-color light, and includes a color combining optical system 110 for synthesis of light of multi-color coherent light sources. The first and second diffractive optical elements 300a and 400a are realized with diffractive optical elements with selectivity on the multi-color wavelength as shown in FIG. 3.

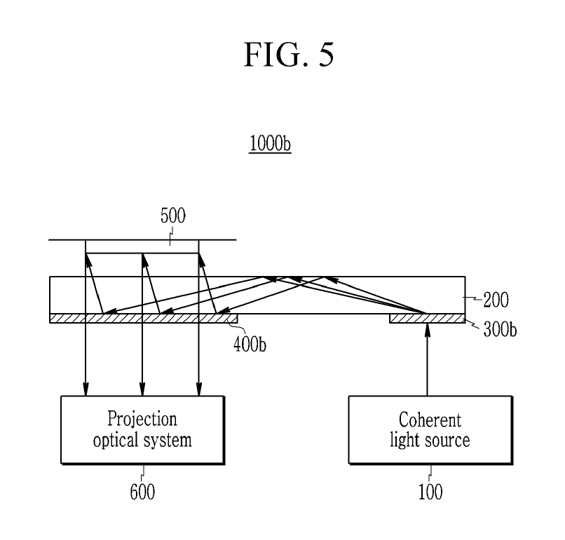

FIG. 5 shows a light modulation system 1000b according to the other exemplary embodiment of the present invention.

The light modulation system 1000b is similar to that described with reference to FIG. 1, except that the first diffractive optical element 300b has a transmissive structure and the second diffractive optical element 400b has a reflective structure. As shown in FIG. 5, the first diffractive optical element 300b and the second diffractive optical element 400b is provided on the same side as that where the coherent light source 100 is formed with respect to the optical waveguide 200.

As shown in FIG. 5, the optical beams from the coherent light source 100 are input to the first diffractive optical element 300b. The first diffractive optical element 300b has a transmissive structure, and it changes the angle of the optical beams so that the input optical beams may be refracted and expanded and the optical beams may be totally reflected and proceed in the optical waveguide 200.

The second diffractive optical element 400b inputs the optical beams in a diffusion form such that they are totally reflected and transmitted in the optical waveguide 200 to the DMD 500. The second diffractive optical element 400b has a reflective structure and it reflects the optical beam to diffuse (or extend) the same, and it changes the angle of the optical beams so as to satisfy the condition of the incident angle (2θ) required by the DMD 500.

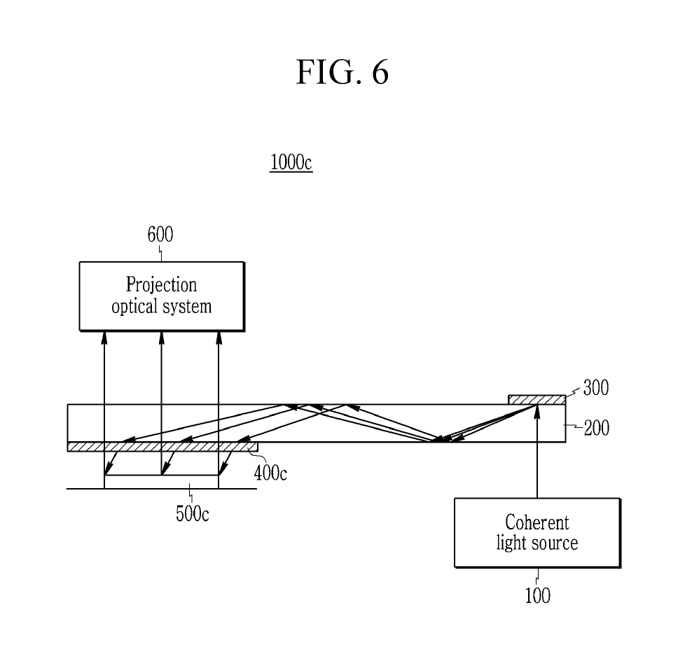

FIG. 6 shows a light modulation system 1000c according to the other exemplary embodiment of the present invention.

The light modulation system 1000c is similar to that described with reference to FIG. 1, except that the input direction of the optical beams from the coherent light source 100 corresponds to the output direction of the optical beams modulated by the DMD 500c.

As shown in FIG. 6, the first diffractive optical element 300 is provided on an upper side with respect to the optical waveguide 200, and the second diffractive optical element 400c and the DMD 500c are provided on a lower side with respect to the optical waveguide 200. The first diffractive optical element 300 has a reflective structure, and the second diffractive optical element 400c has a transmissive structure. By changing the positions of the second diffractive optical element 400c and the DMD 500c as described, the input direction of the optical beams from the coherent light source 100 and the output direction of the optical beams modulated by the DMD 500c may be set to be identical. In another way, when the reflective or transmissive structures of the first diffractive optical element 300 and the second diffractive optical element 400c are configured to be different, the directions of the input optical beams and the output optical beams may be set to be identical.

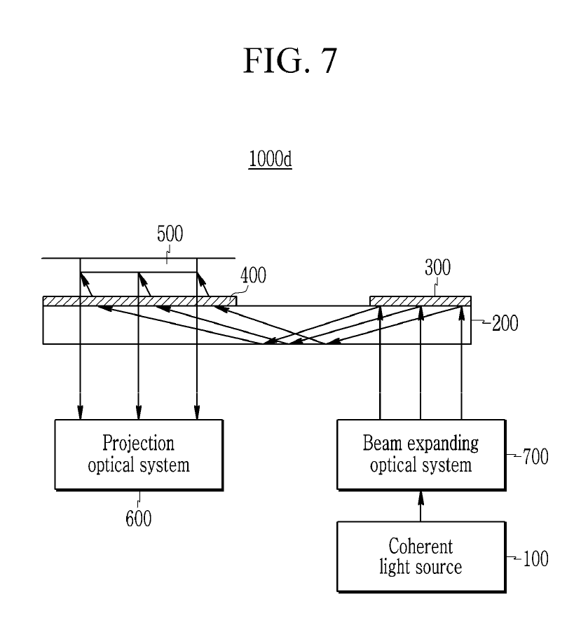

FIG. 7 shows a light modulation system 1000d according to the other exemplary embodiment of the present invention.

The light modulation system 1000d is similar to the light modulation system 1000 described with reference to FIG. 1, except that a beam expanding optical system 700 is additionally provided.

As shown in FIG. 7, regarding the light modulation system 1000d, the beam expanding optical system 700 is provided between the first diffractive optical element 300 and the coherent light source 100. The beam expanding optical system 700 extends the optical beams from the coherent light source 100 and outputs the resultant beams to the first diffractive optical element 300. The beam expanding optical system 700 may be realized through a beam expanding optical element such as a convex lens. The light modulation system 1000d of FIG. 7 additionally extends the beams through the beam expanding optical system 700 thereby further down-sizing the light modulation system 1000d.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A light modulation system comprising:
a first diffractive optical element for expanding optical beams from a light source;
an optical waveguide for performing total internal reflection to the expanded optical beams and transmitting resultant optical beams;
a second diffractive optical element for modifying an angle of the transmitted optical beams; and
a digital micro-mirror device for modulating the angle-modified optical beams.

2. The light modulation system of claim 1, wherein
the second diffractive optical element additionally extends the transmitted optical beams.

3. The light modulation system of claim 1, wherein
the first diffractive optical element and the second diffractive optical element are provided on the optical waveguide.

4. The light modulation system of claim 1, wherein
the first diffractive optical element changes a path of the optical beams from the light source so that the expanded optical beams may be totally reflected on the optical waveguide.

5. The light modulation system of claim 1, wherein
the light source has a multi-color wavelength, and
the first diffractive optical element and the second diffractive optical element have selectivity on the multi-color wavelength.

6. The light modulation system of claim 1, wherein
the first diffractive optical element has a reflective structure, the second diffractive optical element has a transmissive structure, and
the first diffractive optical element and the second diffractive optical element are provided on an opposite side of a place where the light source is provided with respect to the optical waveguide.

7. The light modulation system of claim 1, wherein
the first diffractive optical element has a transmissive structure, the second diffractive optical element has a reflective structure, and
the first diffractive optical element and the second diffractive optical element are provided on a same side of a place where the light source is provided with respect to the optical waveguide.

8. The light modulation system of claim 1, wherein
the first diffractive optical element has a reflective structure, the second diffractive optical element has a transmissive structure,
the first diffractive optical element is provided on an opposite side of a place where the light source is provided with respect to the optical waveguide, and the second diffractive optical element and the digital micro-mirror device are provided on a same side of the place where the light source is provided with respect to the optical waveguide.

9. The light modulation system of claim 1, further comprising
a projection optical system for projecting the modulated optical beams.

10. The light modulation system of claim 1, wherein
the light source is a coherent light source.

11. The light modulation system of claim 1, further comprising
a beam expanding optical system for expanding the optical beams from the light source and outputting the expanded optical beams to the first diffractive optical element.

12. The light modulation system of claim 1, wherein
the second diffractive optical element converts the transmitted optical beams into a waveform for optical modulation.

13. A light source illumination device for changing optical beams from a light source and transmitting resultant optical beams to a spatial light modulator, comprising:
a first diffractive optical element for expanding the optical beams;
an optical waveguide for applying total internal reflection of the expanded optical beams and transmitting resultant optical beams; and
a second diffractive optical element for inputting the transmitted optical beams into the spatial light modulator.

14. The light source illumination device of claim 13, wherein
the second diffractive optical element additionally extends the transmitted optical beams.

15. The light source illumination device of claim 13, wherein
the first diffractive optical element changes a path of the optical beams from the light source so that the expanded optical beams may be totally reflected on the optical waveguide.

16. The light source illumination device of claim 13, wherein
the first diffractive optical element has a reflective structure, the second diffractive optical element has a transmissive structure, and
the first diffractive optical element and the second diffractive optical element are provided on an opposite side of a place where the light source is provided with respect to the optical waveguide.

17. The light source illumination device of claim 13, wherein
the first diffractive optical element has a transmissive structure, the second diffractive optical element has a reflective structure, and
the first diffractive optical element and the second diffractive optical element are provided on a same side of a place where the light source is provided with respect to the optical waveguide.

18. The light source illumination device of claim 13, further comprising
a beam expanding optical system for expanding the optical beams from the light source and outputting the expanded optical beams to the first diffractive optical element.

19. A method for operating a light modulation system for modulating optical beams generated by a light source, comprising:
expanding optical beams from the light source by using a first diffractive optical element;
applying total internal reflection of the expanded optical beams and transmitting resultant optical beams;
modifying an angle of the transmitted optical beam by using a second diffractive optical element; and
modulating the angle-modified optical beams.

20. The method of claim 19, further comprising
changing a path of the optical beams from the light source by using the first diffractive optical element so that the expanded optical beams may be totally reflected.
